(19) United States
(12) Patent Application Publication
(10) Pub. No.: US 2019/0264490 A1
(43) Pub. Date: Aug. 29, 2019

(54) SELF-DRAINING THRESHOLD FOR EXTERIOR DOORWAYS

(71) Applicant: Giovanni Careri, Vaughan (CA)

(72) Inventor: Giovanni Careri, Vaughan (CA)

(73) Assignee: Tru Tech Corporation, Vaughan (CA)

(21) Appl. No.: 15/907,727

(22) Filed: Feb. 28, 2018

(51) Int. Cl. E06B 1/70; E06B 7/23

(52) U.S. Cl. CPC E06B 1/70; E06B 7/2312; E06B 7/2316

(57) ABSTRACT

A self-draining threshold component for a building opening for an exterior doorway having a wooden base member, an interior PVC channel, a lower extension on the PVC channel defining flanges engaging one edge of the wooden base, an aluminum sill base connected with the PVC channel, a downward extension on the sill base having a flange which engages another edge of the wooden base, and an aluminum tread above the sill base, and downward extensions of the aluminum tread inter engaged with the sill base, the PVC channel and the aluminium tread having drain holes to drain liquids to the exterior.

### FIELD OF THE INVENTION

The invention relates to door frames for exterior doors and in particular to a threshold for such an exterior door having a wooden or composite base and PVC components which protect the wooden base and an aluminum tread which provides a long lasting, weatherproof exterior appearance.

### BACKGROUND OF THE INVENTION

In many forms of construction in particular residential building construction, wood is used to construct door frames. For exterior doors It is common to provide the doors themselves of composite construction. The core of the door may be wood or polyurethane foam, or a combination, and in many cases, an outer door, covering is made of metal. Such doors can be made to standard dimensions.

The door frames into which such doors are hung, whether of solid wood or composite construction, must be built to withstand weathering and have an extended useful life. It was often found that the door frame must be adjusted to accept the standard dimensions of the door. Wood door frame components, such as were used in the past, were supplied, in many cases as a kit of components, top and side components with various trim formations. Bottom frame components or so called thresholds were also provided in many cases. These door frame components were then fitted to and attached to the building fabric. Often the use of edge fillers, wedge pieces and the like, was required to provide a door frame of the correct dimensions to accept a standard door.

This work was time consuming. In the case of outside doors, connecting between the interior of the building and the outside, when once erected the door frame exterior was finished with wood preservative, and several coats of undercoat and exterior coats of paint. The threshold was also subjected to continuous wear as persons walked in from the outdoors. Rain and snow are brought in on the shoes, or may be forced under the door by the wind, and can cause damage.

Over time, the exposure to weathering, and the continuous wear, would require repair and replacement of the threshold.

Eventually the wood might deteriorate and require to be removed and replaced.

Door frames might incorporate a stop or ledge against which the door would close, or at least an additional trim might be secured to the door frame after it was erected so as to provide a stop. However in the case of the threshold, it was not practicable to provide such a door stop or shoulder, since it might not create a sufficient barrier against wind and water penetration. It is helpful to understand that in this discussion, dealing with doors on the outside of a building, the use of the words “interior” and “exterior” will be confined to the direction in which the door is swung open or swung closed. The portion of the door frame on the inside where the door would swing open will be referred to as the interior. The portion of the door frame which will be beyond the door stop when the door is closed, will be referred to as the exterior portion of the frame.

The construction of the threshold must therefor take into account not only the extreme wear that will be experienced, but also must be compatible with the design and appearance of the other components of the door frame, i.e. the frame top and side members.

The threshold must also incorporate, in most cases, a gently sloping tread area, allowing for a difference in level between the entry platform or porch, outside the building, usually concrete, and the interior of the building, which is usually somewhat higher.

The threshold component should preferably be enabled to be used with a variety of different exterior doors and door frames, so that these desirable features can be available to the tastes and choices of the building designer, and even the customer buying the building. With recently increased market requirements for better air/water/structural performance and improved thermal insulation, a modern threshold design requires a self-draining feature. Such feature should be able to allow draining of liquids to the exterior at stronger winds, and also highly reduced air infiltration to meet new standards. As well as improved structural integrity with the other door frame, door components, higher pressures and the use of materials that would provide increased durability for its life and avoid deterioration.

BRIEF SUMMARY OF THE INVENTION

A self-draining threshold component for a building opening for an exterior doorway and comprising;

a base member, an interior PVC channel portion, a lower extension on the channel portion defining flanges for engaging one edge of the base, an aluminum sill base connectable with the channel portion, a downward extension on the sill base having a flange adapted to engage another edge of the base, and an aluminum tread portion above said sill base, and downward extensions of said metallic tread portion inter engage able with said sill base.

Preferably, the PVC channel portion will define parallel vertical side walls defining the channel, a base wall extending between said side walls, said base wall being angled downwardly from one said side wall to the other and drain openings in one said side wall.

Preferably, the sill base will incorporate fastening grooves formed therein, and wherein said tread portion downward extensions incorporate locking abutments, inter fittable with said grooves of said sill base.

The sill base may incorporate a sill extension extending beyond said core, and a support leg on the outer end of said sill base extension.

Preferably, the invention further provides weather stripping for the lower edge of the door, a resilient flexible sealing strip supported by said weather stripping, and inter engagable with said channel, and a flexible sweep member.

Preferably, the weather stripping comprises a generally T-shaped member attachable to the under side of said door, and supporting said flexible sealing member and said flexible sweep.

Preferably, a further weather stripping is provided, supporting a further flexible sealing strip, inter engageable with said aluminum tread portion.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 is a front elevation of a typical door, and door frame illustrating the environment of the invention;

FIG. 2 is a sectional elevation of the threshold component and door of FIG. 1 along line 2-2;

FIG. 3 is a section of a channel portion of FIG. 2 along line 3-3;

FIG. 4 is a perspective of the channel of FIG. 3;

FIG. 5 is an enlarged section of a metal tread portion of FIG. 2;

FIG. 6 is an enlarged section of the tread support portion of FIG. 2;

FIG. 7 is a section showing the components of FIG. 5 and when assembled together;

FIG. 8 is a section of the lower edge of the door of FIG. 2 showing inner and outer door sweeps;

FIG. 9 is an enlarged section of the inner door sweep of FIG. 8;

FIG. 10 is a perspective of FIG. 9;

FIG. 11 is a section of the outer door sweep of FIG. 9;

FIG. 12 is a perspective of the outer door sweep of FIG. 11;

FIG. 13 is a section similar to FIG. 2 showing optional additional extensions.

### DESCRIPTION OF A SPECIFIC EMBODIMENT

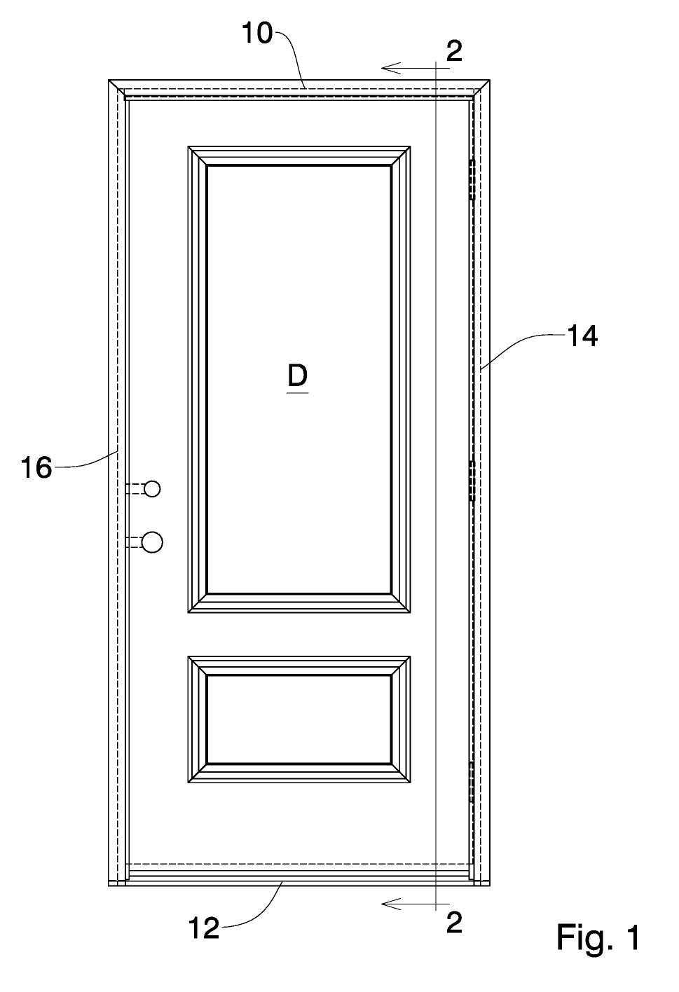

FIG. 1 is shown merely to illustrate the environment of the invention in general.

FIG. 1 is a front elevation of the typical door (D) and a door frame in which the door is hung, the frame is indicated generally as top frame component (10), bottom frame component (12), hinge side frame component (14), and lock side frame component (16).

In the past wooden frame components were usually machined and milled to provide the appearance required by the builder. In some cases, wooden frame components were simply planar planks, which were secured to the building fabric around the opening. Separate trim portions were secured to the wooden planks to provide door stops. It is, however, the preferred practise to provide prefabricated milled wooden frame components which incorporate integral door stops, and which define interior core portions and exterior core portions.

At the building site they would then be fastened to the building fabric around the doorway opening in the building. In more recent times the practice has been to provide a form of synthetic frame cladding material typically PVC. This would provide door frame components which were essentially protected from weathering.

All of this is very well known in the construction industry and has been the practice for years.

In addition, door frames around the outside at least of the building may be provided with additional trim pieces where the door opening might require additional trim pieces or extensions to provide coverage between the outside of the building fabric and the door frame and draft exclusion strips.

These trim and extension components will desirably be PVC and inter fit with the door cladding on the door frames themselves and can be inter fitted together and then appear as a single component.

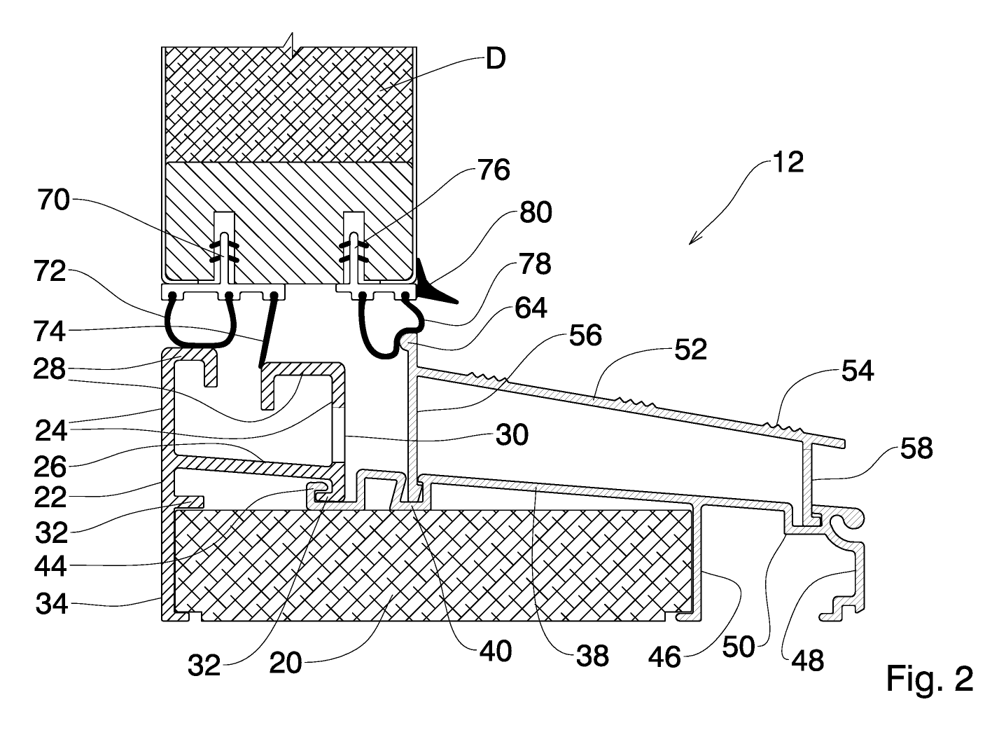

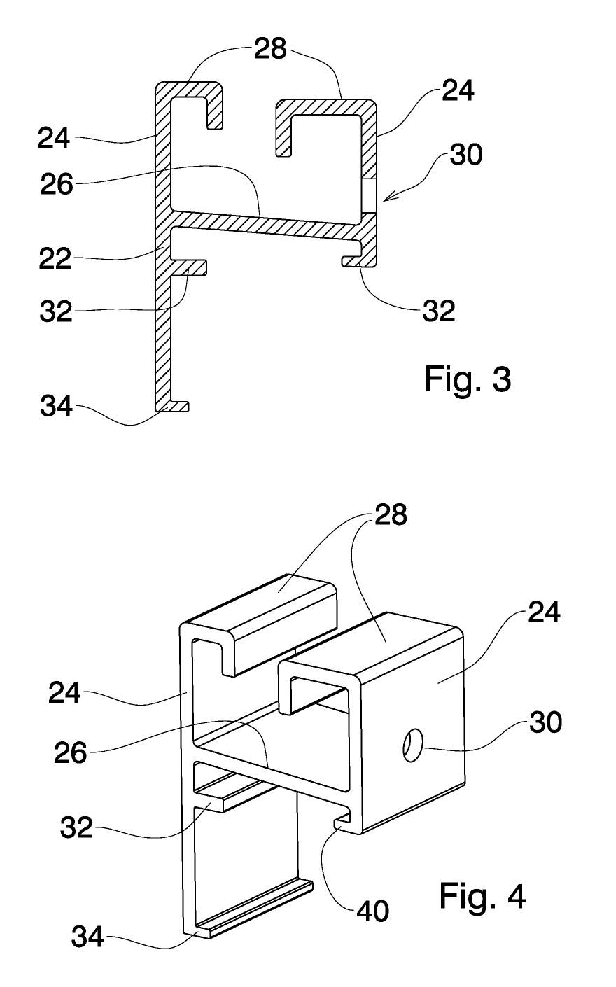

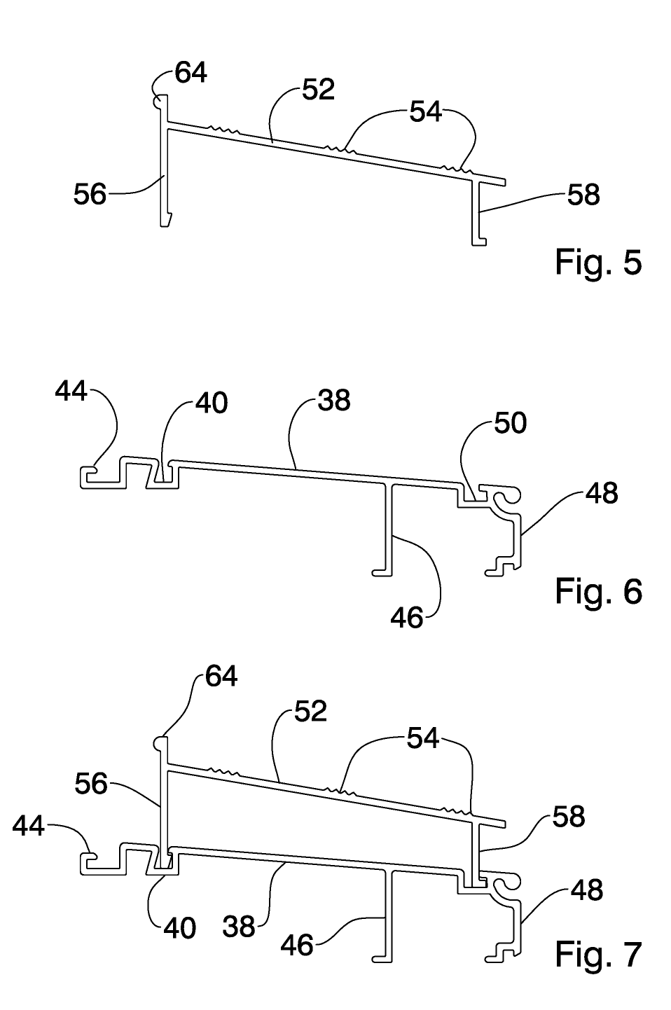

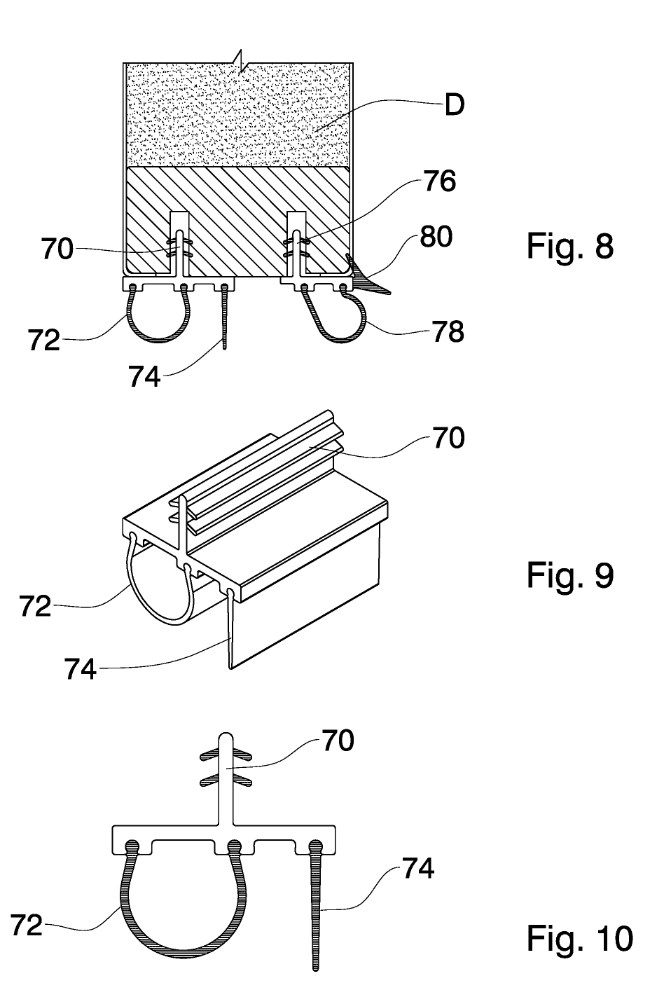

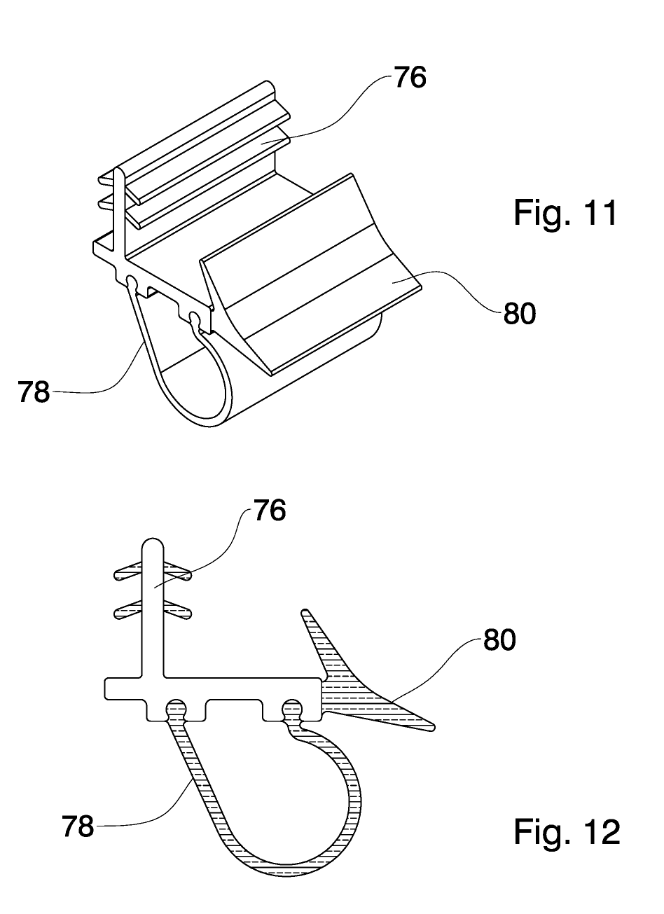

Referring now to FIG. 2, it will be seen that it illustrates the lower door frame or threshold member (12) which can be attached across the threshold of the doorway in the building fabric.

The threshold has a base (20) which is this case is a rectangular wooden member fitting between the two door frame side members, and fastened to them to provide a complete door frame of the correct dimension. The base defines an inner edge, and an exterior edge, and an upper side and an under side. The upper side of the base member (20) is enclosed by separate inner and outer cover portions.

The inner cover portion comprises the extrusion (22). This is formed of rigid PVC, in this embodiment. It defines an open channel having cover side walls (24) and a bottom wall (26) The upper edges of the side walls are formed with L shaped flanges (28), turned inwardly into the channel. The outer side wall is lower than the inner side wall.

The bottom wall (26) is angled down towards the exterior. Drainage holes (30) are formed in the outer one of the cover side walls to allow any water collected in the channel to drain towards the exterior.

On the underside of bottom wall (26) there are inner and exterior cover locking flanges (32) formed on downward extensions of the side walls (24).

An inner hook flange (34) extends downwardly below the interior one of cover locking flanges (32). This hook flange is dimensioned to fit around and grasp the inner edge of the wooden base (20).

The exterior cover portion or sill base is formed of aluminum in this embodiment.

It has a planar base wall (38) formed along a slope directed downwardly towards the exterior.

Along the inner edge of base wall (38) there is base locking channel (40) of inverted U-shape, extending upwardly between the cover channel wall (34) and the exterior cover portion. A base connector member extends inwardly from the base locking groove (40), and terminates with an inner hook (44).

Hook (44) co-operates with the outer one of the cover locking flanges (32) of the inner cover portion.

Extending below the underside of base wall (38) there is an outer base hook flange (46) dimensioned to fit around and hold the exterior edge of the wooden base (20).

In this way, the exterior edge of the wooden base is sandwiched between the base wall (38), and the outer base hook flange (46).

In this way the inner and the exterior cover portions are connected together around the wooden base and secure the wooden base.

The base wall (38) extends towards the exterior, beyond the exterior edge of the wooden base (20), and terminates in a vertical wall (48). The vertical wall is formed with a generally U-shaped channel (50), for reasons to be described below. A tread member (52) also of mostly aluminium material, is attached to the upper side of the sill base. The tread member has a generally downwardly angled tread wall formed with frictional tread (54) formations in most cases—which will allow for any excessive water to escape faster. The tread wall is supported on an inner tread wall support (56), and an outer tread wall support (58). The inner tread support wall is of a greater height than the outer tread support wall, thereby defining a sloping surface. The inner vertical side wall of the tread portion is formed at its lower end with an abutment fitting within the fastening groove (40) of the sill base. The inner tread support wall (56) is extended above the level of the tread wall, and is formed with an abutment (64) which will become part of the draft exclusion system, to be described below. The exterior tread support wall (58) is formed with an abutment, fitting within the groove (50) on the exterior end of the sill base. In this way, the tread wall can be attached to the sill base, and is supported at its inner and outer ends.

In order to provide for draft exclusion, in the area between the lower edge of the door D, and the inner and outer cover portions, an inner T-shaped member (70) is provided, with an upright leg extending into a slot in the under side of the door. The lower portion of the T-shaped member is provided with an inner flexible draft strip (72), and an inner sweep member (74). The inner draft strip, and sweep member engage respective portions of the inner cover portion channel side walls as shown. An exterior draft exclusion strip of generally L-shaped (76), it has an upright member extending into a separate slot in the under side of the door. The transverse portion of the L-shaped member supports an exterior draft flexible draft exclusion member (78) and an exterior sweep member (80). The exterior draft exclusion member engages with the abutment (64) on the upper portion of the tread support wall (56).

The entire threshold as described cooperates with the door D, and provides for effective and long-lasting draft exclusion and minimum water penetration, and weather proofing. In the event that any moisture collects in the inner cover portion, it can drain outwardly through drain holes (30) in the outer side wall of the channel. Any such moisture then will drain from end to end around the base connector member (40).

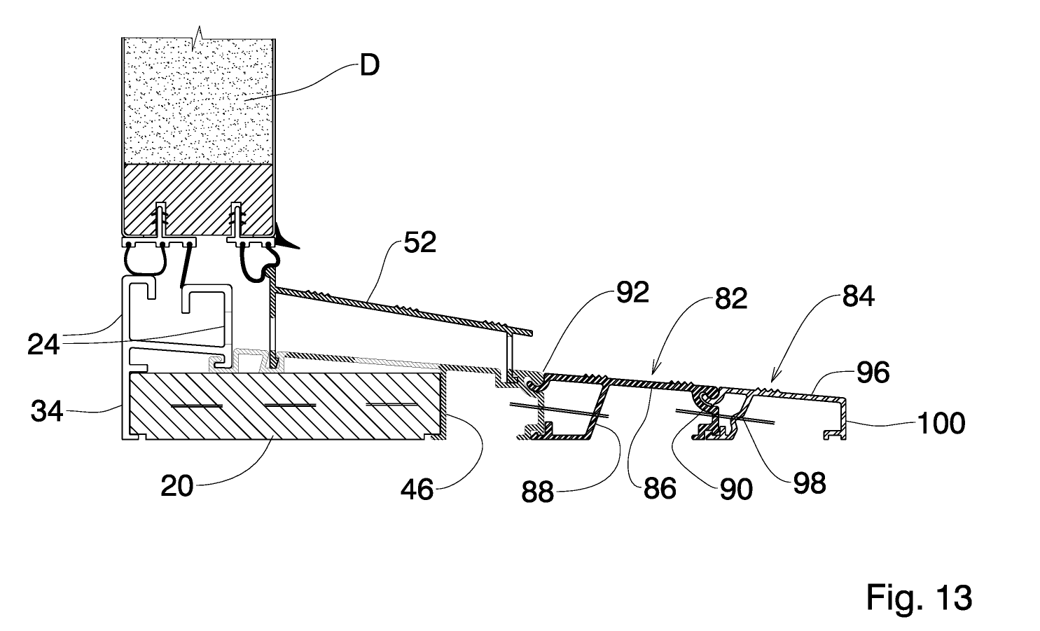

In some cases, depending on the design of the building and of the building porch, it may be desirable to extend the tread of the threshold. This can be done by means of the tread extender shown in FIG. 13 also of aluminum. This consists of an intermediate extender (82), and a terminal extender (84). The intermediate extender comprises an extender tread wall (86). The extender tread wall (86) is supported by an intermediate diagonal support wall (88), and an end wall (90). A generally hook shaped extender lock (92) is provided to fit within the U-shaped channel (50) of the sill base.

The terminal extender is of generally similar construction, defining an extender tread wall (96), and an inner support diagonal wall (98) with a U-shaped lock. An outer end wall (100) supports the opposite end of the terminal extender.

The intermediate extender and the terminal extender may all be connected together by means such as fasteners as shown on FIG. 13.

The foregoing is a description of a preferred embodiment of the invention which is given here by way of example only. The invention is not to be taken as limited to any of the specific features as described, but comprehends all such variations thereof as come within the scope of the claims.

What is claimed is:

1. A self-draining threshold component for a building opening for an exterior doorway and comprising;
a wooden base member defining an interior edge and an exterior edge, and a top surface and an under surface;
an interior channel portion of synthetic material adapted to collect moisture;
a drain opening in said channel portion;
a lower leg on the channel portion defining channel flanges for engaging the interior edge of the wooden base member;
an aluminum sill base separate from said channel portion adapted to receive moisture from said channel portion;
connectors on said sill base connectable with the channel portion;
a sill downward leg on the sill base having a flange adapted to engage the exterior edge of the wooden base;
an aluminum tread portion above said sill base, and
tread downward legs of said tread portion inter engage able with said sill base.

2. The self-draining threshold component for a building opening for an exterior doorway as claimed in claim 1 and wherein the channel portion defines parallel vertical inner and exterior side walls defining the channel, a base wall extending between said side walls, said base wall being angled downwardly from said inner side wall to said exterior side wall and drain openings in said exterior side wall whereby liquid collecting in said channel portion may be drained towards the exterior, through said drain openings.

3. The self-draining threshold component for a building opening for an exterior doorway as claimed in claim 1 and wherein the sill base incorporates fastening grooves formed therein, and wherein said tread portion downward legs incorporate locking abutments, inter fittable with said grooves of said sill base.

4. The self-draining threshold component for a building opening for an exterior doorway as claimed in claim 1 and wherein the sill base incorporates a sill ledge extending beyond said wooden base, and a support leg on the outer end of said sill ledge.

5. The self-draining threshold component for a building opening for an exterior doorway as claimed in claim 2, and including a locking flange formed on the underside of said channel bottom wall, and wherein said sill base incorporates a hook engagable with said locking flange, whereby to inter connect said channel portion with said sill base.

6. The self-draining threshold component for a building opening for an exterior doorway as claimed in claim 5 wherein said sill base fastening grooves comprise an inner fastening groove and an exterior fastening groove, and including a locking extension formed alongside said inner fastening groove, and said hook member being formed on said locking extension.

7. The self-draining threshold component for a building opening for an exterior doorway as claimed in claim 6 wherein said channel flanges on said lower leg of said channel portion comprise upper and lower flanges spaced apart to fit around said inner edge of said wooden base.

8. The self-draining threshold component for a building opening for an exterior doorway as claimed in claim 7, and wherein said channel portion side walls comprise an inner side wall, and an exterior side wall spaced apart from one another, and an inner L-shaped member along the upper edge of said inner channel side wall, and an outer L-shaped member formed along the upper edge of said exterior channel side wall, and wherein said exterior channel side wall is of a predetermined first height, and wherein said interior channel side wall is of a predetermined second height, greater than said first height.

9. The self-draining threshold component for a building opening for an exterior doorway as claimed in claim 8, and wherein said tread portion downward legs define an inner tread and an exterior tread, wherein said inner tread is of a greater height than said exterior tread, and wherein said tread portion incorporates an upwardly extending draft exclusion ridge.

10. The threshold component for a building opening for an exterior doorway as claimed in claim 9, and including a base extender, separate from said sill base, and attachable to said sill base, and wherein said sill base end wall defines a U-shaped groove, and wherein said base extender defines a hook inter engagable with said U-shaped groove.

11. The self-draining threshold component for a building opening for an exterior doorway as claimed in claim 10 and including an endwise base extender attachable to said base extender, whereby to define a continuously sloping tread surface.

12. The self-draining threshold component for a building opening for an exterior doorway as claimed in claim 9 and including weather stripping engageable with the lower edge of the door, a resilient flexible sealing strip supported by said weather stripping, and including a flexible sweep member.

13. The self-draining threshold component for a building opening for an exterior doorway as claimed in claim 12 and wherein the weather stripping comprises a generally T-shaped inner member attachable to the under side of said door supporting said flexible sealing member and said flexible sweep, inter engagable with said channel.

14. The self-draining threshold component for a building opening for an exterior doorway as claimed in claim 13 and including an L-shaped exterior weather stripping, and an exterior flexible sealing strip, inter engage able with said metallic tread portion.

15. The self-draining threshold component for a building opening for an exterior doorway as claimed in claim 14 and wherein said exterior flexible sealing strip inter engages with said draft excluding ridge of said tread portion.

16. The self-draining threshold component for a building opening for an exterior doorway as claimed in claim 15 and wherein said exterior weather stripping supports an exterior sweep member on said L-shaped member.
